(19) United States
(12) Patent Application Publication
(10) Pub. No.: US 2008/0062358 A1
(43) Pub. Date: Mar. 13, 2008

(54) LIQUID CRYSTAL PANEL AND LIQUID CRYSTAL DISPLAY

(75) Inventors: Chian-Chang Lee, Taichung City (TW); Chin-Chang Liu, Taichung County (TW); Chien-Chung Kuo, Taichung County (TW)

Correspondence Address: J C PATENTS, INC., 4 VENTURE, SUITE 250, IRVINE, CA, 92618, US

(73) Assignee: WINTEK CORPORATION, Taichung (TW)

(21) Appl. No.: 11/834,929

(22) Filed: Aug. 7, 2007

(30) Foreign Application Priority Data
Sep. 12, 2006 (TW) 95133607

(51) Int. Cl. G02F 1/1335; G02F 1/1337; G02F 1/1343

(52) U.S. Cl. 349/103; 349/123; 349/143

(57) ABSTRACT

A liquid crystal display (LCD) and a liquid crystal panel thereof are provided. The LCD includes a backlight module and the liquid crystal panel disposed thereon. The liquid crystal panel has a first substrate, a second substrate, and a positive liquid crystal layer. The first substrate has a plurality of pixel electrodes, and each pixel electrode has a plurality of first strip-shape portions. The second substrate has a common electrode, and the common electrode has a plurality of second strip-shape portions. The positive liquid crystal layer is interposed between the pixel electrodes of the first substrate and the common electrode of the second substrate and is vertically aligned. The corresponding areas of the first and the second strip-shape portions are staggered.

### CROSS-REFERENCE TO RELATED APPLICATION

This application claims the priority benefit of Taiwan application serial no. 95133607, filed on Sep. 12, 2006. All disclosure of the Taiwan application is incorporated herein by reference.

### BACKGROUND OF THE INVENTION

1. Field of the Invention

The present invention relates to a liquid crystal panel and a liquid crystal display (LCD), and more particularly to a liquid crystal panel and a liquid crystal display (LCD) with wide viewing angles.

2. Description of Related Art

With big leaps in the techniques of manufacturing opto-electronics and semiconductor devices, flat panel displays (FPDs) have been vigorously developed. Among the flat panel displays, the liquid crystal display (LCD) is widely applied to replace the traditional CRT display little by little, and has become the mainstream display product due to its advantages of low operating voltage, free of harmful radiation, light weight, and small and compact size. However, the viewing angle restriction of the LCD still exists. To date, the LCDs with high contrast ratio, no gray scale inversion, low color shift, high luminance, full color, high color saturation, high responsive speed, and wide viewing angles are required. In order to achieve the purpose of wide viewing angles, some displays, such as twisted nematic (TN) liquid crystals with wide-view films, in-plane switching (IPS) LCDs, fringe field switching (FFS) LCDs, and multi-domain vertically alignment (MVA) LCDs, are developed to accomplish the purpose. Following are the descriptions of the conventional MVA-LCDs.

FIGS. 1 and 2 are partial sectional views of two conventional liquid crystal panels of multi-domain vertical alignment LCDs. Referring to FIGS. 1 and 2, in order to develop a display region with a multi-domain alignment, a bump 110 is formed in a liquid crystal panel 100, while a via 210 is formed in a liquid crystal panel 200. Nevertheless, both the bump 110 and the via 210 comprise bevels. Thus, liquid crystal molecules 120 and 220 are arranged in a direction not completely vertical to substrates 130 and 230 due to the impact of boundary energy, as are shown in FIGS. 1 and 2. In consequence, without applying an electric field to the liquid crystal molecules 120 and 220, the liquid crystal panels 100 and 200 have a phase difference (Δnd) while being seen in a positive viewing angle because of the tilting liquid crystal molecules 120 and 220, and accordingly a light leakage occurs. To eliminate the light leakage, a compensating film (not shown) is required to improve displaying contrast. Furthermore, it is customary for the liquid crystal molecules 120 and 220 to be made of negative liquid crystals which are at higher expenses, further increasing the costs of the conventional MVA- LCDs.

### SUMMARY OF THE INVENTION

Accordingly, the present invention provides a liquid crystal panel featuring a wide viewing angle and a low cost.

The present invention provides a liquid crystal display (LCD) featuring a wide viewing angle and a low cost.

The present invention provides a liquid crystal panel, which comprises a first substrate, a second substrate, and a positive liquid crystal layer. The first substrate comprises a plurality of pixel electrodes, and each pixel electrode comprises a plurality of first strip-shape portions. The second substrate comprises a common electrode, and the common electrode comprises a plurality of second strip-shape portions. The positive liquid crystal layer is interposed between the pixel electrodes of the first substrate and the common electrode of the second substrate and is vertically aligned. The corresponding areas of the first and the second strip-shape portions are staggered.

The present invention further provides a liquid crystal display (LCD), which comprises a backlight module and said liquid crystal panel. The liquid crystal panel is disposed above the backlight module.

In one embodiment of said liquid crystal panel and said LCD, the first and the second strip-shape portions are line-shaped. In addition, the first strip-shape portions may be parallel to the second strip-shape portions.

In one embodiment of said liquid crystal panel and said LCD, the first and the second strip-shape portions are zigzag-shaped or wave-shaped. In addition, the first strip-shape portions are, for example, parallel to the second strip-shape portions.

In one embodiment of said liquid crystal panel and said LCD, the first substrate further comprises a first alignment film. The first alignment film covers the pixel electrodes and contacts the positive liquid crystal layer so as to establish a vertical alignment.

In one embodiment of said liquid crystal panel and said LCD, the second substrate further comprises a second alignment film. The second alignment film covers the common electrode and contacts the positive liquid crystal layer so as to establish a vertical alignment.

In one embodiment of said liquid crystal panel and said LCD, the pixel electrodes are made of a transparent conductive material or metal.

In one embodiment of said liquid crystal panel and said LCD, the pixel electrodes are made of indium tin oxide (ITO) or indium zinc oxide (IZO).

In one embodiment of said liquid crystal panel and said LCD, the common electrode is made of a transparent conductive material or metal.

In one embodiment of said liquid crystal panel and said LCD, the common electrode is made of ITO or IZO.

In one embodiment of said liquid crystal panel and said LCD, a width of the first strip-shape portions and that of the second strip-shape portions range from 1 mm to 15 mm, respectively.

In one embodiment of said liquid crystal panel and said LCD, a distance between any two adjoining first strip-shape portions and that between any two adjoining second strip-shape portions range from 10 mm to 50 mm, respectively.

In one embodiment of said liquid crystal panel and said LCD, a distance between any two adjoining first strip-shape portions and second strip-shape portions ranges from 5 mm to 30 mm as the first and the second strip-shape portions are seen in a vertical view.

In one embodiment of said liquid crystal panel and said LCD, the liquid crystal panel further comprises two polarizers respectively positioned at a side of the first substrate and a side of the second substrate opposite to the positive liquid crystal layer. Liquid crystal molecules of the positive liquid crystal layer are driven and then tilted in a pre-tilt direction, and an angle between a light absorbing axis of one of the polarizers and the pre-tilt direction is substantially 45 degrees. The light absorbing axes of the polarizers are perpendicular to each other.

In one embodiment of said liquid crystal panel and said LCD, a light path differential of the positive liquid crystal layer ranges from 250 nm to 350 nm.

In one embodiment of said liquid crystal panel and said LCD, a thickness of the positive liquid crystal layer ranges from 1.5 nm to 6 nm.

In summary, according to the liquid crystal panel and the LCD of the present invention, a display region with at least two domains is developed through an adoption of the positive liquid crystal layer and a horizontal electric field formed by the staggered first and second strip-shape portions, achieving a wide viewing angle. Furthermore, since the positive liquid crystals are less expensive than the negative liquid crystals, metal can be directly used during the process of manufacturing the pixel electrodes so as to avoid a transparent electrode (ITO or IZO) process and to yield micro reflectance. Thereby, the costs of the liquid crystal panel and the LCD disclosed in the present invention can be reduced.

In order to the make aforementioned and other features and advantages of the present invention comprehensible, preferred embodiments accompanied with figures are described in detail below. For illustrative convenience, the drawings cannot be looked as a dedicated size or scale. In the scope of this invention, any structure and material described in the following text can be modified properly.

### BRIEF DESCRIPTION OF THE DRAWINGS

FIGS. 1 and 2 are partial sectional views of two conventional liquid crystal panels of multi-domain vertical alignment LCDs.

FIGS. 3A and 3B are partial sectional views respectively illustrating an LCD before and after a voltage is applied to a liquid crystal layer according to one embodiment of the present invention.

FIG. 4 is a top view of the LCD as shown in FIG. 3A.

FIGS. 5 to 9 are schematic top views of pixel electrodes and a common electrode in a pixel region according to five embodiments of the present invention.

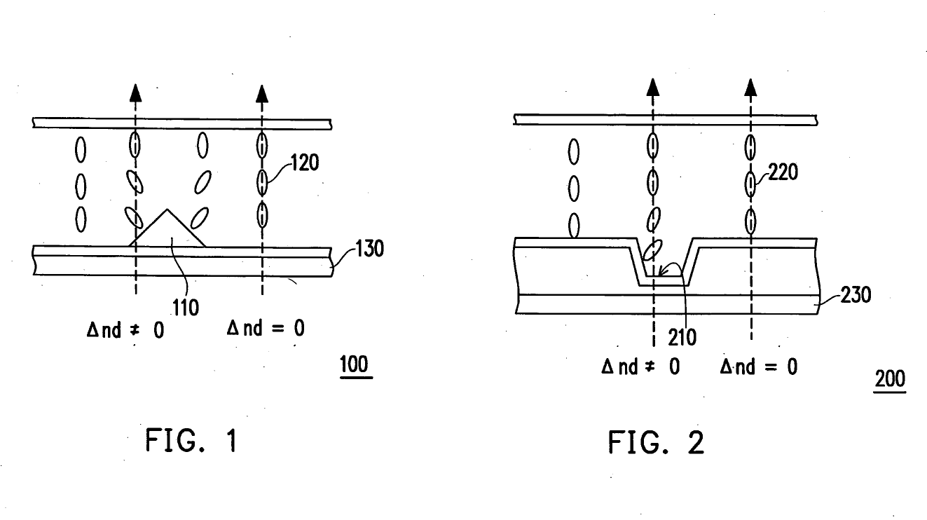

### DESCRIPTION OF EMBODIMENTS

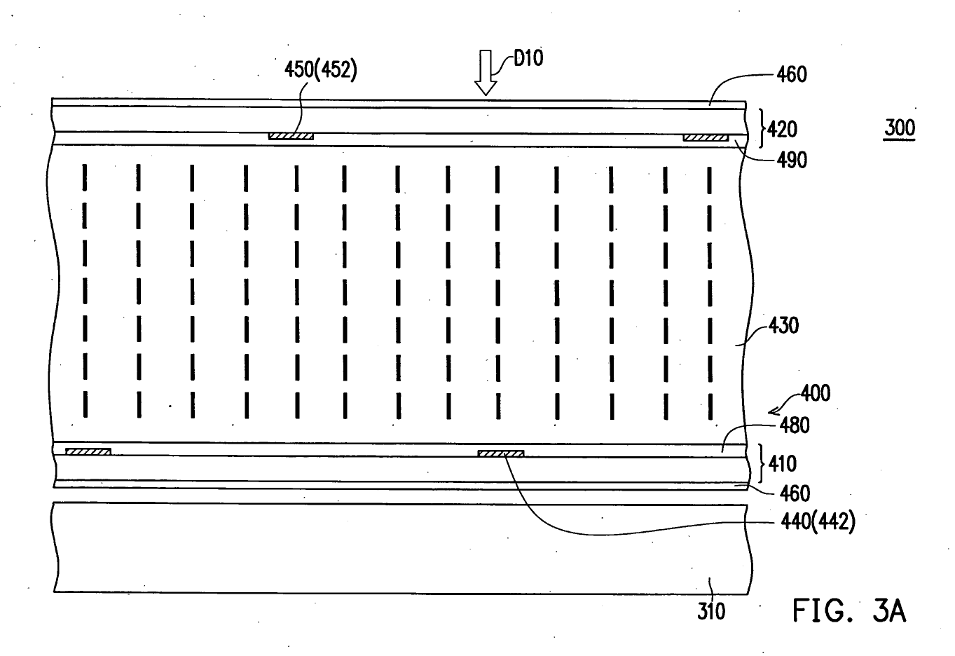

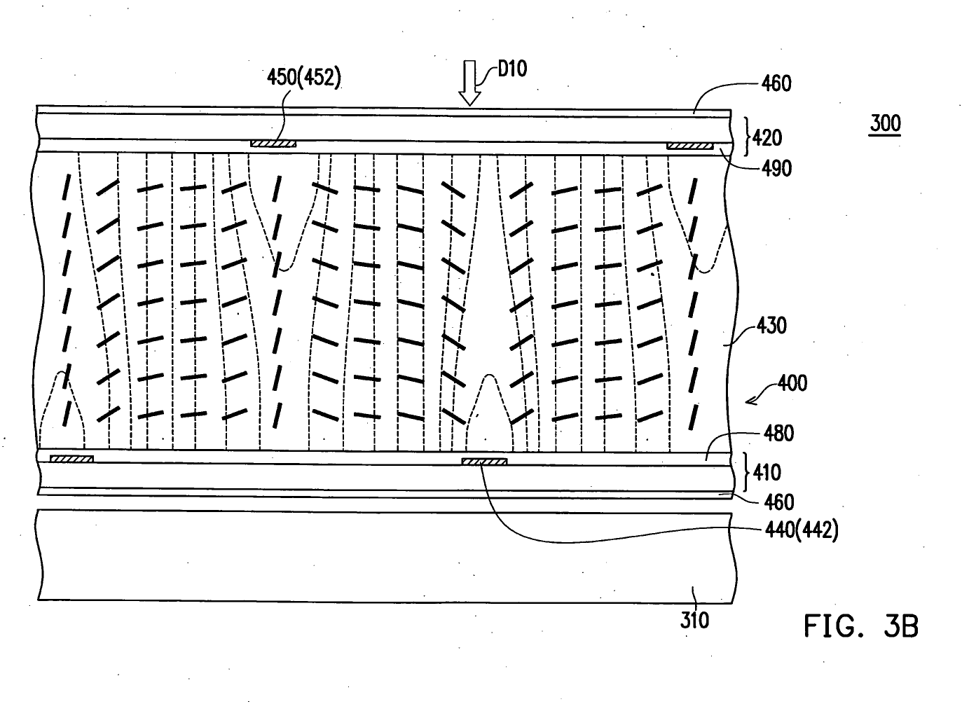

FIGS. 3A and 3B are partial sectional views respectively illustrating a liquid crystal display (LCD) before and after a voltage is applied to a liquid crystal layer according to one embodiment of the present invention. FIG. 4 is a top view of the LCD as is shown in FIG. 3A.

Referring to FIG. 3A, a liquid crystal display (LCD) 300 of the present embodiment comprises a backlight module 310 and a liquid crystal panel 400. The liquid crystal panel 400 is disposed above the backlight module 310 so as to display images through a planar light source provided by the backlight module 310. Given the liquid crystal panel 400 adopts a reflective or a transflective design, it is of certainty that the liquid crystal panel 400 is still capable of displaying images without jointly utilizing the backlight module 310. The backlight module 310 is any of an apparatus which provides a planar light source; therefore, a detailed description of the backlight module 310 is then omitted.

Referring to FIGS. 3A and 4, the liquid crystal panel 400 of the present embodiment comprises a first substrate 410, a second substrate 420, and a positive liquid crystal layer 430. The first substrate 410 comprises a plurality of pixel electrodes 440, and each pixel electrode 440 comprises a plurality of first strip-shape portions 442. The second substrate 420 comprises a common electrode 450, and the common electrode 450 comprises a plurality of second strip-shape portions 452. Liquid crystal molecules of the positive liquid crystal layer 430 are characterized by a positive dielectric anisotropy. The positive liquid crystal layer 430 is interposed between the pixel electrodes 440 of the first substrate 410 and the common electrode 450 of the second substrate 420 and is vertically aligned. Specifically, the positive liquid crystal layer 430 is sandwiched between the first substrate 410 and the second substrate 420, and both the pixel electrodes 440 and the common electrode 450 are adjacent to the positive liquid crystal layer 430. In a viewing direction D10 perpendicular to the first substrate 410 and the second substrate 420, as shown in FIG. 4, the corresponding areas of the first strip-shape portions 442 and the second strip-shape portions 452 are staggered. In other words, the first strip-shape portions 442 and the second strip-shape portions 452 are not overlapping in the direction D 10.

As is stated above, since the first strip-shape portions 442 and the second strip-shape portions 452 are staggered, an arrangement of equipotential lines indicated in FIG. 3B (in dotted lines) are developed while a voltage difference is applied to the first strip-shape portions 442 and the second strip-shape portions 452. It is known from the arrangement of the equipotential lines in FIG. 3B that a horizontal electric field is about to be formed between the first strip-shape portions 442 and the second strip-shape portions 452. Since the liquid crystal molecules of the positive liquid crystal layer 430 tend to rotate to be parallel to the electric field, the proportion of a light passing through the liquid crystal layer 430 is controlled so as to achieve a display effect. Likewise, since the electric fields formed at both sides of the first strip-shape portions 442 are different, a display region with two domains is further generated so as to achieve a wide viewing angle. Namely, the liquid crystal molecules of the positive liquid crystal layer 430 are driven as those of the conventional MVA-LCDs. Moreover, neither a bump nor a via is provided by the LCD 300 of the present embodiment. Accordingly, no light leakage occurs, and no extra compensation film is required. Also, the positive liquid crystal layer 430 adopted by the LCD 300 of the present embodiment has an advantage of low costs in comparison with the negative liquid crystals.

In the present embodiment, the first strip-shape portions 442 and the second strip-shape portions 452 are line-shaped. However, the first strip-shape portions 442 and the second strip-shape portions 452 may have other shapes, and several examples are provided below for further illustration. In addition, the first strip-shape portions 442 are, for example, parallel to the second strip-shape portions 452. Moreover, the liquid crystal panel 400 may further comprise two polarizers 460 which are respectively disposed at a side of the first substrate 410 and a side of the second substrate 420 opposite to the positive liquid crystal layer 430, as is shown in FIG. 3A. The liquid crystal molecules of the positive liquid crystal layer 430 are driven and then tilted in a pre-tilt direction D20, and an angle between a light absorbing axis of one of the polarizers 460 and the pre-tilt direction D20 is substantially, for example, 45 degrees. The light absorbing axes of the polarizers 460 are perpendicular to each other.

Additionally, the first substrate 410 comprises a first alignment film 480. The first alignment film 480 covers the pixel electrodes 440 and contacts the positive liquid crystal layer 430 so as to establish a vertical alignment. Similarly, the second substrate 420 may comprise a second alignment film 490. The second alignment film 490 covers the common electrode 450 and contacts the positive liquid crystal layer 430 so as to establish a vertical alignment. In FIGS. 3A and 3B, the liquid crystal molecules of the positive liquid crystal layer 430 are driven in a vertical alignment.

Besides, both the pixel electrodes 440 and the common electrode 450 may be made of a transparent conductive material, metal, or other conductive materials, including indium tin oxide (ITO) or indium zinc oxide (IZO), for example.

And, regardless of the shapes which the first strip-shape portions 442 and the second strip-shape portions 452 have, the liquid crystal panel 400 may still comprise two polarizers 460 respectively positioned at a side of the first substrate 410 and a side of the second substrate 420 opposite to the positive liquid crystal layer 430, as is shown in FIG. 3A. The light absorbing axes of the two polarizers 460 are perpendicular to each other, for example.

Furthermore, a light path differential of the positive liquid crystal layer 430 ranges from 250 nm to 350 nm, for example. A thickness of the positive liquid crystal layer 430 ranges from 1.5 nm to 6 nm, for example.

Referring to FIGS. 3A and 4, in the liquid crystal panel 400, the first substrate 410 is an active device matrix substrate, for example. Specifically, the first substrate 410 comprises a plurality of active devices 412, for example. The active devices 412 may be thin film transistors (TFTs) or other active devices. Each active device 412 is electrically coupled to a pixel electrode 440 and is controlled by a data line 414 and a scan line 416. In addition, the second substrate 420 is, for example, a color filter substrate, so that the liquid crystal panel 400 can display color images. Obviously, the first substrate 410 may also adopt a color filter on array (COA) technology, and thereby the liquid crystal panel 400 can display color images as well.

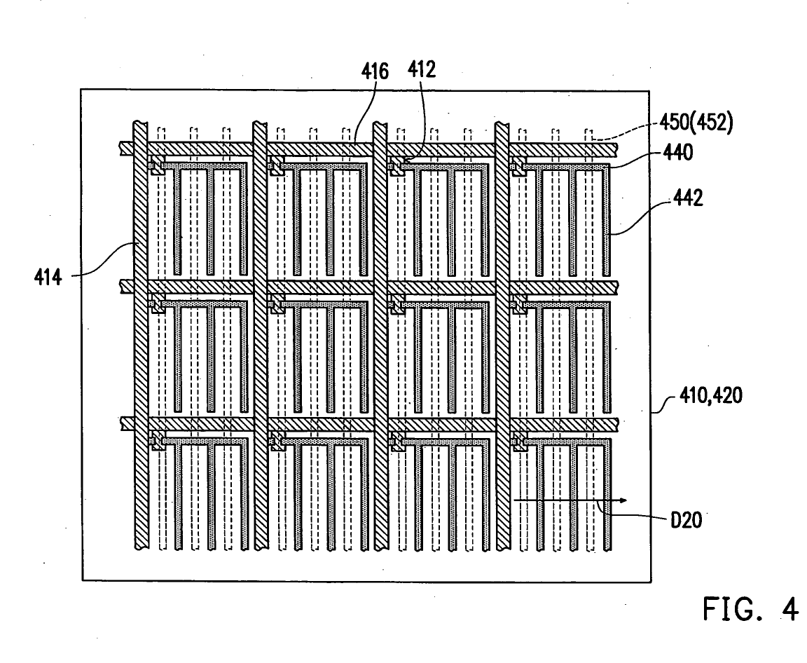

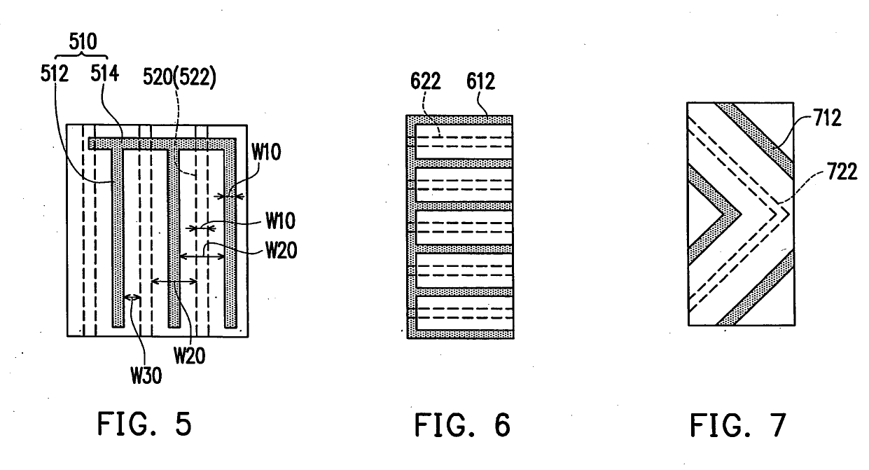

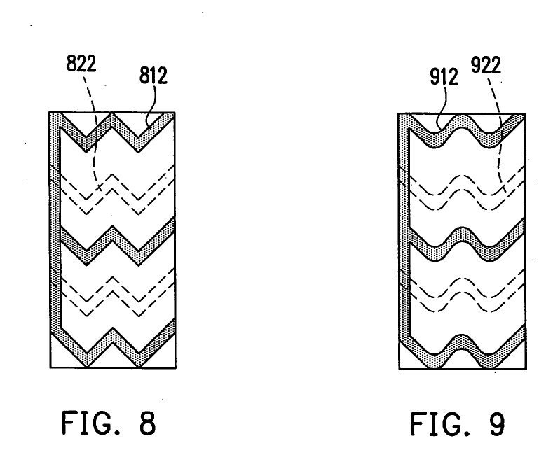

FIGS. 5 to 9 are schematic top views of pixel electrodes and a common electrode in a pixel region according to five embodiments of the present invention. In FIG. 5, the pixel electrodes 510 comprise a plurality of first strip-shape portions 512 and a connecting portion 514 connecting all the first strip-shape portions 512 together. The common electrode 520 comprises a plurality of second strip-shape portions 522. Both the first strip-shape portions 512 and the second strip-shape portions 522 are line-shaped, forming a comb structure. In FIG. 6, both the first strip-shape portions 612 of the pixel electrodes and the second strip-shape portions 622 of the common electrode are line-shaped and parallel to the short sides of the rectangular pixel region. In FIG. 7, both the first strip-shape portions 712 of the pixel electrodes and the second strip-shape portions 722 of the common electrode are zigzag-shaped; likewise, in FIG. 8, the first strip-shape portions 812 of the pixel electrodes and the second strip-shape portions 822 of the common electrode are zigzag-shaped as well. In FIG. 9, both the first strip-shape portions 912 of the pixel electrodes and the second strip-shape portions 922 of the common electrode are wave-shaped. In the above embodiments, the first strip-shape portions 512, 612, 712 are parallel to the second strip-shape portions 522, 622, 722, for example.

Referring to FIG. 5, a width W10 of the first strip-shape portions 512 and the width W10 of the second strip-shape portions 522 range from 1 mm to 15 mm, respectively. Besides, a distance W20 between any two adjoining first strip-shape portions 512 and the distance W20 between any two adjoining second strip-shape portions 522 range from 10 mm to 50 mm, respectively. In addition, as is illustrated in FIG. 5, a distance W30 between any two adjoining first strip-shape portions 512 and second strip-shape portions 522 range from 5 mm to 30 mm as the first substrate and the second substrate are seen in a vertical view.

In view of the foregoing, the liquid crystal panel and the LCD disclosed in the present invention aim at designing the pixel electrodes having the first strip-shape portions and the common electrode having the second strip-shape portions. Meanwhile, the staggered first and second strip-shape portions are utilized along with the positive liquid crystal layer. Since a horizontal electric field is produced by the first and the second strip-shape portions, the liquid crystal molecules of the positive liquid crystal layer tend to rotate to be parallel to the electric field, so as to accomplish a gray scale display effect. Also, since the electric fields formed at both sides of one first strip-shape portion are different, a display region with at least two domains can be generated so as to achieve a wide viewing angle. Given zigzags or other designs are applied to the first and the second strip-shape portions, a display region with more domains can be further obtained. Finally, the liquid crystal panel and the LCD of the present invention have advantages of lower costs and zero light leakage.

It will be apparent to persons of ordinary skill in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A liquid crystal panel, comprising:
a first substrate, comprising a plurality of pixel electrodes, wherein each of the pixel electrode comprises a plurality of first strip-shape portions;
a second substrate, comprising a common electrode, wherein the common electrode comprises a plurality of second strip-shape portions; and
a positive liquid crystal layer, interposed between the pixel electrodes of the first substrate and the common electrode of the second substrate and vertically aligned, wherein corresponding areas of the first strip-shape portions and of the second strip-shape portions are staggered.

2. The liquid crystal panel of claim 1, wherein the first and the second strip-shape portions are line-shaped.

3. The liquid crystal panel of claim 2, wherein the first strip-shape portions are parallel to the second strip-shape portions.

4. The liquid crystal panel of claim 1, wherein the first and the second strip-shape portions are zigzag-shaped or wave-shaped.

5. The liquid crystal panel of claim 4, wherein the first strip-shape portions are parallel to the second strip-shape portions.

6. The liquid crystal panel of claim 1, wherein the first substrate further comprises a first alignment film covering the pixel electrodes and contacting the positive liquid crystal layer so as to establish a vertical alignment.

7. The liquid crystal panel of claim 1, wherein the second substrate further comprises a second alignment film covering the common electrode and contacting the positive liquid crystal layer so as to establish a vertical alignment.

8. The liquid crystal panel of claim 1, further comprising two polarizers respectively positioned at a side of the first substrate and a side of the second substrate opposite to the positive liquid crystal layer, wherein liquid crystal molecules of the positive liquid crystal layer are driven and then tilted in a pre-tilt direction, and an angle between a light absorbing axis of one of the polarizers and the pre-tilt direction is substantially 45 degrees, the light absorbing axes of the polarizers being vertical to each other.

9. The liquid crystal panel of claim 1, wherein the pixel electrodes are made of a transparent conductive material or metal.

10. The liquid crystal panel of claim 1, wherein the pixel electrodes are made of indium tin oxide (ITO) or indium zinc oxide (IZO).

11. The liquid crystal panel of claim 1, wherein the common electrode is made of a transparent conductive material or metal.

12. The liquid crystal panel of claim 1, wherein the common electrode is made of ITO or IZO.

13. The liquid crystal panel of claim 1, wherein a width of the first strip-shape portions and that of the second strip-shape portions range from 1 mm to 15 mm, respectively.

14. The liquid crystal panel of claim 1, wherein a distance between any two adjoining first strip-shape portions and that between any two adjoining second strip-shape portions range from 10 mm to 50 mm, respectively.

15. The liquid crystal panel of claim 1, wherein a distance between any two adjoining first strip-shape portions and second strip-shape portions ranges from 5 mm to 30 mm as the first substrate and the second substrate are seen in a vertical view.

16. The liquid crystal panel of claim 1, wherein a light path differential of the positive liquid crystal layer ranges from 250 nm to 350 nm.

17. The liquid crystal panel of claim 1, wherein a thickness of the positive liquid crystal layer ranges from 1.5 nm to 6 nm.

18. A liquid crystal display (LCD), comprising:
a backlight module;
a liquid crystal panel, disposed above the backlight module, wherein the liquid crystal panel comprises:
a first substrate, comprising a plurality of pixel electrodes, wherein each of the pixel electrode comprises a plurality of first strip-shape portions;
a second substrate, comprising a common electrode, wherein the common electrode comprises a plurality of second strip-shape portions; and
a positive liquid crystal layer which is interposed between the pixel electrodes of the first substrate and the common electrode of the second substrate and is vertically aligned, the corresponding areas of the first strip-shape portions and of the second strip-shape portions being staggered.

19. The LCD of claim 18, wherein the first and the second strip-shape portions are line-shaped.

20. The LCD of claim 19, wherein the first strip-shape portions are parallel to the second strip-shape portions.

21. The LCD of claim 18, wherein the first and the second strip-shape portions are zigzag-shaped or wave-shaped.

22. The LCD of claim 21, wherein the first strip-shape portions are parallel to the second strip-shape portions.

23. The LCD of claim 18, wherein the first substrate further comprises a first alignment film covering the pixel electrodes and contacting the positive liquid crystal layer so as to establish a vertical alignment.

24. The LCD of claim 18, wherein the second substrate further comprises a second alignment film covering the common electrode and contacting the positive liquid crystal layer so as to establish a vertical alignment.

25. The LCD of claim 18, further comprising two polarizers respectively positioned at a side of the first substrate and a side of the second substrate opposite to the positive liquid crystal layer, wherein liquid crystal molecules of the positive liquid crystal layer are driven and then tilted in a pre-tilt direction, and an angle between a light absorbing axis of one of the polarizers and the pre-tilt direction is substantially 45 degrees, the light absorbing axes of the polarizers being vertical to each other.

26. The LCD of claim 18, wherein the pixel electrodes are made of a transparent conductive material or metal.

27. The LCD of claim 18, wherein the pixel electrodes are made of indium tin oxide (ITO) or indium zinc oxide (IZO).

28. The LCD of claim 18, wherein the common electrode is made of a transparent conductive material or metal.

29. The LCD of claim 18, wherein the common electrode is made of ITO or IZO.

30. The LCD of claim 18, wherein a width of the first strip-shape portions and that of the second strip-shape portions range from 1 mm to 15 mm, respectively.

31. The LCD of claim 18, wherein a distance between any two adjoining first strip-shape portions and that between any two adjoining second strip-shape portions range from 10 mm to 50 mm, respectively.

32. The LCD of claim 18, wherein a distance between any two adjoining first strip-shape portions and second strip-shape portions ranges from 5 mm to 30 mm as the first substrate and the second substrate are seen in a vertical view.

33. The LCD of claim 18, wherein a light path differential of the positive liquid crystal layer ranges from 250 nm to 350 nm.

34. The LCD of claim 18, wherein a thickness of the positive liquid crystal layer ranges from 1.5 nm to 6 nm.
